(19) United States
(12) Patent Application Publication
(10) Pub. No.: US 2005/0010668 A1
(43) Pub. Date: Jan. 13, 2005

(54) Traversable network address translation with hierarchical internet addressing architecture

(76) Inventor: Shiwen Chen, Marlboro, NJ (US)

Correspondence Address: HARNESS, DICKEY & PIERCE, P.L.C., P.O. BOX 828, BLOOMFIELD HILLS, MI, 48303, US

(21) Appl. No.: 10/614,542

(22) Filed: Jul. 7, 2003

(51) Int. Cl. G06F 15/16

(52) U.S. Cl. 709/227

(57) ABSTRACT

An improved method is provided for routing data packets in a packet-switched network. Data packets are routed to or from network devices residing in a private network by using hierarchical network addressing information which is embedded into the options field of an IP packet header. The proposed framework is compatible with conventional data routing protocols as well as supports applications requiring peer-to-peer communication.

### FIELD OF THE INVENTION

The present invention relates to network address translation and, more particularly, to an improved protocol for routing data packets using traversable hierarchical network addressing.

### BACKGROUND OF THE INVENTION

With the explosion of the Internet, the number of available Internet Protocol (IP) addresses are insufficient to meet the demand. Although an IPv6 network architecture has been proposed to deal with the address shortage, IPv4 remains prevalent. Network address translation (NAT) is one approach that helps solve the address shortage in the IPv4 environment, but it brings challenges and difficulties for certain applications.

In general, a NAT capable device maintains a private network and translates private network host addresses to certain public addresses when these hosts are communicating with public network hosts. However, it introduces complications to many applications. For example, a host in the public domain is not able to initiate a TCP connection to a host behind a NAT router. Although this could bring some security value, it brings inconvenience to peer to peer applications. One such application is IP telephony, either the H.323 signaling or the RTP stream may encounter problems with NAT routers. As Internet applications continue to grow exponentially, it becomes more and more difficult for vendors to adapt to various peer to peer applications, and yet it makes application development difficult without resolving the NAT traversal issue.

The present invention proposes a new framework and mechanism for a NAT router which supports peer-to-peer applications. The framework is compatible with existing IP routing and network address translation mechanisms, and allows IP networks to be extended to support new applications.

### SUMMARY OF THE INVENTION

In accordance with the present invention, an improved method is provided for routing data packets in a packet-switched network. Data packets are routed to or from network devices residing in a private network by using hierarchical network addressing information which is embedded into the options field of an IP packet header. The proposed framework is compatible with conventional data routing protocols as well as supports applications requiring peer-to-peer communication.

In one aspect, the private IP address for an originating network device is embedded in the options field for data packets being sent to a destination outside of the private network. In another aspect, the private IP address for a destination network device residing in a private network is embedded in the options field.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram depicting a portion of an exemplary network illustrating the hierarchical structure of the network;

FIG. 2 is a diagram depicting the format of a packet header in accordance with the Internet Protocol;

FIG. 3 is a flowchart depicting an exemplary routing protocol performed by a router for data packets being sent from a network device residing in a private network in accordance with the present invention;

FIG. 4 is a diagram illustrating the operation of the exemplary routing protocol shown in FIG. 3 in accordance with the present invention;

FIG. 5 is a flowchart depicting an exemplary routing protocol performed by a router for data packets being sent to a network device residing in a private network in accordance with the present invention;

FIG. 6 is a diagram illustrating the operation of the exemplary routing protocol shown in FIG. 5 in accordance with the present invention

### DETAILED DESCRIPTION OF THE PREFERRED EMBODIMENTS

A network address translation mechanism brings both advantage of extending the IP network address space, and difficulties to implement peer-to-peer network communications due to use of non-routable private IP addresses. Therefore, the present invention defines an hierarchical addressing mechanism which allows global identification of any hosts that are connected to the public internet through specially configured router devices. This scheme is referred to as a “traversable hierarchical IP addressing scheme”. This addressing scheme considers almost all possible internet connection types: host directly connected to the Internet with a public IPv4 address; and host in a private network which is connected to the public Internet with one or more routing devices.

The proposed addressing scheme uses existing addresses that hosts have been assigned, and therefore requires no new address assignment and allocation scheme. In general, consider that any host that connects to the Internet has a unique traversable hierarchical IP address (THIA), which is composed of addresses of the host's existing allocated IP address, and the public network interface address of routing devices interposed between the host and a public network.

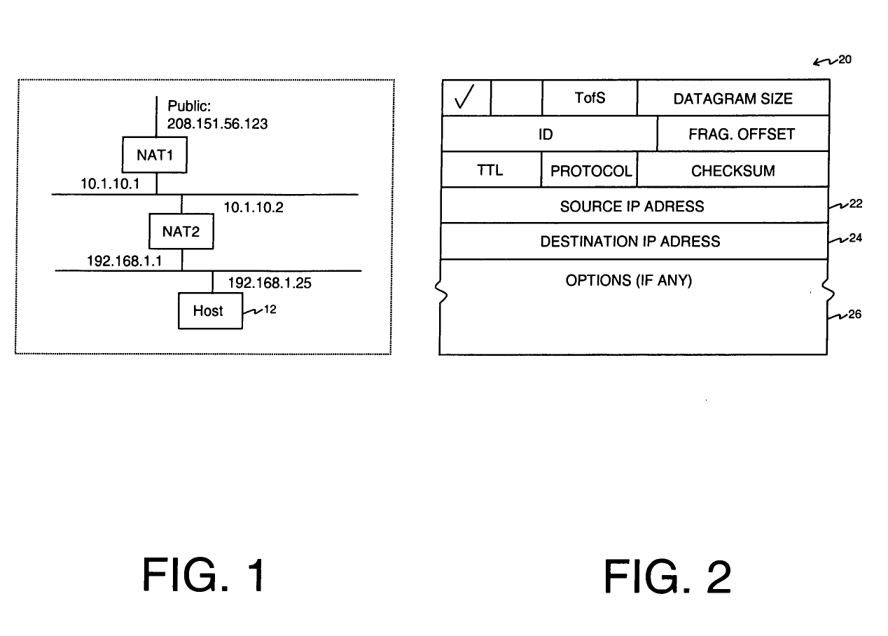

Referring to FIG. 1, suppose an exemplary host 12 is assigned with a private IP address of 192.168.1.25, and that there are two exemplary routers cascaded in between this host 12 and the Internet. The router directly connecting the Internet has the address of 208.151.56.123 for its public side network interface, while the other one has the address of 10.1.10.2 as its public side network interface address. Then, define the host's THIA to be the ordered concatenation of the three addresses. For clarity reason, the host's THIA is notated as the three addresses concatenated to each other with a colon as a separator as follows: “208.151.56.123:10.1.10.2:192.168.1.25”. As shown, THIA begins with the public interface address of the outer-most router and ends with the host's private assigned address.

More formally, the THIA is defined to be an integer with length to be a muliple of four bytes, every four consecutive bytes corresponds to an IPv4 address of a device. The THIA is in a predefined order so that it reflects the order of the cascaded (if any) routers. In the example above, the outer most router is at the beginning and the host device is at the end. Notation for the THIA uses the traditional IPv4 address notation with colons separating different devices' IP addresses.

FIG. 2 depicts a packet header 20 in accordance with the Internet Protocol (IP). The packet header is generally comprised of multiple 32-bit words. A minimum length packet header is comprised of five 32-bit words, including a source IP address field 22 and a destination IP address field 24. However, an option exists within the header which allows further optional bytes to be added in an options field 26 of the packer header. An IP header length field 28 dictates the number of the optional bytes. Since the IP header length field is a 4 bit number, this implies that the options field may be as long as ten 32-bit words. As further described below, hierarchical network addressing information may be embedded into the options field 26 on an IP packet header in accordance with the present invention. While the following description is provided with reference to the Internet Protocol, it is readily understood that the present invention is suitable for other types of protocols which have the capability of adding optional bits of information into the data packet.

Network address translation is typically performed by a router which sits between a private network and a public network, such as the Internet. In operation, the router is configured to translate an unregistered private IP address which resides on the private network to a globally unique, registered IP address. However, an improved protocol is provided for routing data packets using traversable hierarchical network addressing. Unless explicitly stated, the routers or network routing devices in this document refers to the class of routers with address translation functionality.

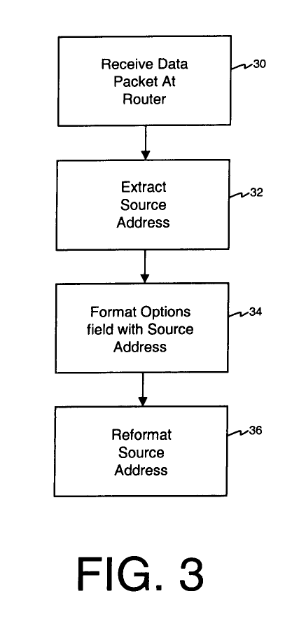

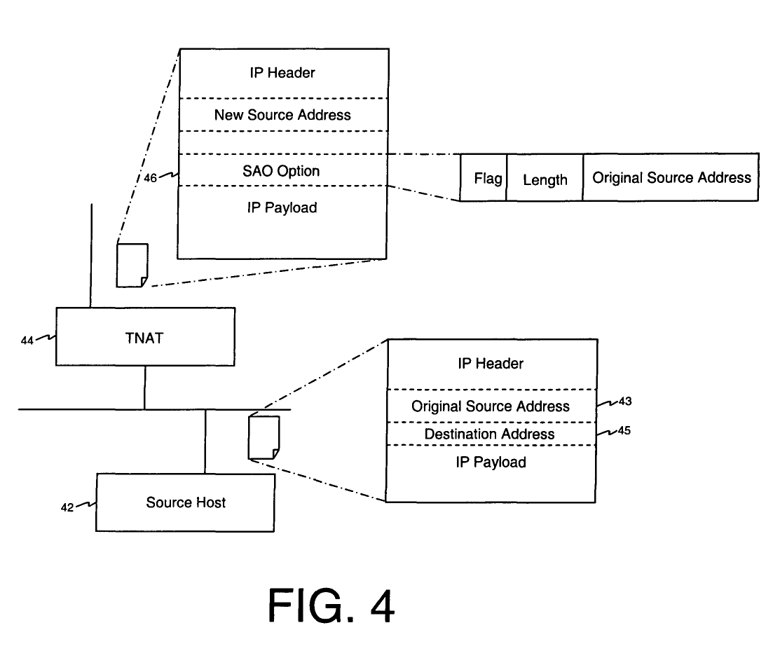

FIGS. 3 and 4 illustrate a routing protocol for data packets being sent from a source host 42 residing in a private network. Initially, data packets are formulated by the source host 42. For instance, the source IP address field of the packet header is formatted with a private IP address 43 for the originating host device 42, and the destination IP address field of the packet header is formatted with a destination IP address 45; it is understood that the remainder of the data packets is also formulated in accordance with the Internet Protocol.

Data packets are then sent by the source host 42. Data packets being sent to a destination outside of the private network are routed through at least one router 44. To preserve the originating source address for subsequent peer-to-peer communication, the router 44 is operative to format the options field 46 of the packet header with the private IP address 43 of the originating host device 42 as shown in FIG. 3. Specifically, data packets are received at step 30 at a private-side interface of the router 44. The private IP address of the originating host device is extracted at step 32 from the source IP address of the packer header and inserted at step 34 into the options field of the packet header.

The options field may be defined to include two types of options: a source address option and a destination address option. Either option may further include a flag byte (octet), a length byte (octet) and one or more IP addresses. Multiple addresses are concatenated together as further described below. It is readily understood that the source address option and the destination address option use different flag values.

Thus, the private IP address of the originating host device is inserted into a source address option defined in the options field of the packet header. The source IP address field of the packet header is then reformatted at step 36 with the public interface IP address for the router 44. Reformatted data packets are then forwarded through the public-side interface of the router 44.

To the extent that multiple routers are interposed between the originating host and the public network, it is readily understood that this process is repeated for each intermediate routing device. In other words, the IP address is extracted from the source IP address field of the packet header and appended to the address information residing in the source address option of the packet header at each router. In addition, the source IP address field is reformatted with the public interface IP address for the given router. Each time a router updates the options field, the packet header is updated accordingly, including the length byte in the source address options. When the data packet is finally sent to the public network, it is readily understood that the source address option is formatted with an IP address for the source device followed by IP addresses for the each intermediate routing device ordered in an inner to outer sequence and the source IP address field is formatted with the public interface address for the outer most router associated with the private network. Thus, each packet header contains source address information that enables peer-to-peer communication with the source host.

Once a data packet is received at its final destination, the embedded source address information may be extracted from the packet header by the destination host. As noted above, the public interface address for the outer most router is found in the source IP address field. The remaining address information is concatenated within the source address option such that the public interface address for the second most outer router is at the end of the source address option (i.e., top of the stack) and the private IP address for the originating host device is at the beginning of the source address option (i.e., bottom of the stack). However, it is to be understood that the address information may be ordered in any predefined manner known to the network devices. The extracted source address may then be used in subsequent communications to establish a peer-to-peer connection with the source host. It should be noted that this approach is compatible with conventional network address translation mechanisms in that entities receiving a data packet may ignore the options field if they don't support the traversable hierarchical network addressing of the present invention.

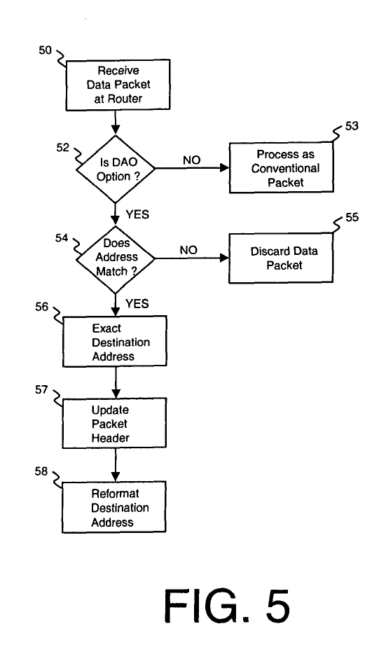

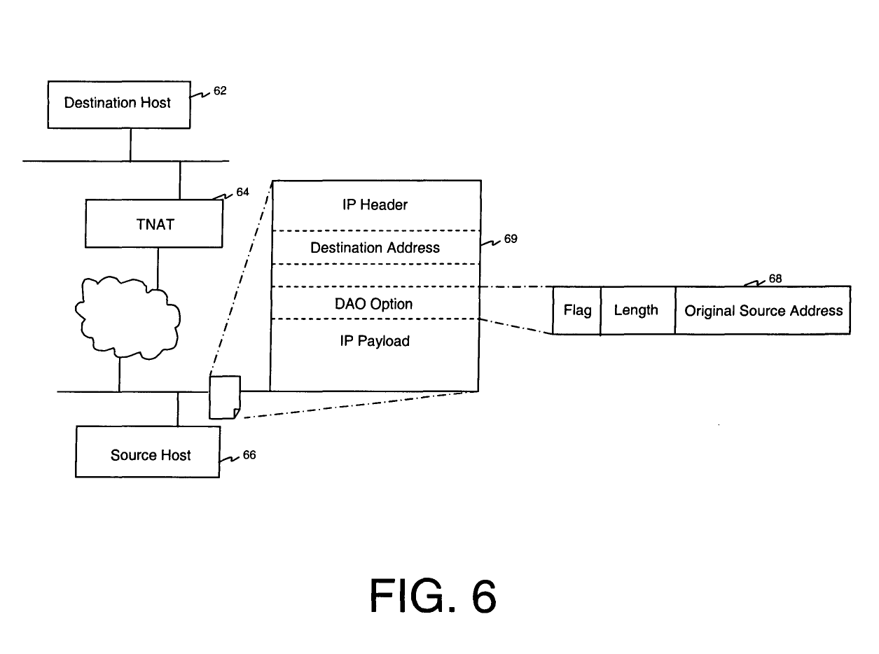

FIGS. 5 and 6 illustrate a routing protocol for data packets being sent to a destination host 62 having a private IP address and residing in a private network. For discussion purposes, it is assumed that destination host IP address is known to the source host 66, and thus is embedded in the data packets being sent to the destination host 62. In one exemplary embodiment, the IP address of the destination host may have been learned in the manner described above. In another exemplary embodiment, the destination host may have registered its tranverable hierarchical network address at a domain name server. Knowing a peer station name, the source host may send a DNS query to retrieve the tranversable hierarchical network address of the destination host. However, it is envisioned that other techniques for learning the destination host IP address are also within the scope of the present invention.

First, the source host 66 must format the packet header with the applicable destination address information. The destination address information is also embedded into options field of the packet header in a manner as described above. In particular, the options field may include a destination address option. The destination address option is further defined to include a flag byte (octet), a length byte (octet) and one or more destination IP addresses. The destination addresses are concatenated together, such that the public interface address for the second most outer router is at the beginning of the address field (i.e., top of the stack) and the private IP address for the destination host device is at the end of the address field (i.e., bottom of the stack). In other words, the destination addresses are ordered in an outer to inner manner in relation to the public network. However, it is to be understood that the address information may be ordered in any predefined manner known to the network devices. It is also readily understood that the public interface address for the outer most router is inserted into the destination IP address field of the packet header. Formatted data packets are then sent by the source host 66.

Data packets being sent to a destination within a private network are routed through at least one router 64. When a data packet arrives at a public side interface of the router 64 disposed between the public network and the destination host 62, the data packet is processed as shown in FIG. 5. The data packet is first assessed to determine if it supports traversable hierarchical network addressing. To do so, the router inspects the options field of the packet header at step 52. If the data packet does not include a destination address option, then the packet is processed as a conventional incoming IP packet as shown at step 53.

Conversely, if the data packet does include at least one destination address in the destination address option, the router then inspects at step 45 the IP address contained in the destination IP address field 69 of the packet header. When the IP address contained in the destination IP address field matches the router's public side interface IP address, the router extracts the destination IP address from the destination address option of the packet header at step 56 and reformats the destination IP address field with the extracted IP address at step 58. More specifically, the router retrieves the outer most destination address from the options field and updates the remainder of the packet header (e.g., IP header length field and option field length) accordingly. The reformatted data packet may then be sent on to the destination host. When the IP address contained in the destination IP address field does not match the router's public side interface IP address, the router discards the packet as shown at 55.

To the extent that multiple routers are interposed between the public network and the destination host, it is readily understood that this process is repeated at each intermediate routing device. In other words, the destination IP address is extracted from the destination address option and inserted into the destination IP address field of the packet header. When the data packet is finally sent to the destination host, it is readily understood that the destination IP address field is formatted with the private IP address for the destination host. Thus, the data packet was routed in a peer-to-peer manner from the source host to the destination host.

It is envisioned that a network device in some instances may desire to learn its own traversable hierarchical network address. For instance, a network device may need to publish or register its traversable hierarchical network address. In these instances, the following protocol may be employed.

Each network routing device may be further configured to process address queries from devices disposed on its private side. In operation, a network device sends an address query message to its gateway requesting its traversable hierarchical network address. The requesting device may maintain a timer so that the query can be repeated if the timer expires without receipt of a reply message. After a predetermined number of retries, the requesting device may discontinue sending queries.

In response to an address query message, the network routing device sends a reply message to the requesting device which contains its traversable hierarchical network address. As previously discussed, a traversable hierarchical network address includes the public interface IP address for the responding network routing device prepended with public interface IP addresses for any other network routing devices interposed between the responding network routing device and the public network. In one embodiment, the responding network routing device may configured use the same protocol to discover the public interface IP addresses of any other network routing devices interposed between the responding network routing device and the public network. Alternatively, the network routing devices may be configured to multicast through its private side interface a notification message that contains its public interface IP address, so that other network devices may learn its address without sending a query message. The notification message may be sent when the device is first powered on or at period time intervals.

The description of the invention is merely exemplary in nature and, thus, variations that do not depart from the gist of the invention are intended to be within the scope of the invention. Such variations are not to be regarded as a departure from the spirit and scope of the invention.

1. A method for routing data packets in a packet-switched network, comprising:
receiving a data packet at a network routing device residing in the network, the data packet being formulated in accordance with the Internet Protocol (IP) and having at least one private IP address embedded in an options field of the packet header;
extracting the at least one private IP address from the options field; and
formatting a destination IP address field of the packet header with the at least one private IP address prior to forwarding the data packet.

2. The method of claim 1 wherein the step of receiving a data packet further comprises receiving the data packet at a public-side interface of the network routing device.

3. The method of claim 1 further comprises forwarding the data packet through a private-side interface of the network routing device.

4. The method of claim 1 further comprises defining the options field of the packet header to include an embedded address indicator which indicates the presence of the at least one private IP address in the options field.

5. The method of claim 1 further comprises formatting the destination IP address field when an IP address residing in the destination IP address of the packet header matches a public-side interface IP address for the network routing device.

6. The method of claim 1 further comprises reformatting the options field to remove the at least private IP address.

7. The method of claim 1 wherein the data packet includes two or more private IP addresses appended to each other in a predefined order within the options field of the packet header.

8. The method of claim 1 further comprises repeating the process at each network routing device interposed between a public network and a destination network device.

9. A network routing device positioned between a private network and a public network in a packet-switched network system, the network routing device adapted to receive data packets at a public-side interface, the data packets being formulated in accordance with Internet Protocol (IP) and having at least one private IP address embedded in a destination address options field of the packet header, the network routing device being operable to extract the at least one private IP address from the destination address options field and format a destination IP address field of the packet header with the at least one private IP address.

10. The network routing device of claim 9 being further operable to format the destination IP address field when an IP address residing in the destination IP address of the packet header matches a public-side interface IP address for the network routing device.

11. The network routing device of claim 9 being further operable to reformat the destination address options field after extracting the at least one private IP address from the options field.

12. The network routing device of claim 9 wherein the data packet includes two or more private IP addresses appended to each other in a predefined order within the options field of the packet header.

13. A method for routing data packets in a packet-switched network, comprising:
receiving a data packet transmitted by an originating network device at a network routing device residing in the network, the data packet being formulated in accordance with the Internet Protocol (IP) and having an original source private IP address in a source IP address field of the packet header and a destination IP address in a destination IP address field of the packet header;
formatting an options field of the packet header with the original source private IP address; and
formatting the source IP address field of the packet header with an IP address for the network routing device prior to forwarding the data packet.

14. The method of claim 13 wherein the step of receiving a data packet further comprises receiving the data packet at a private-side interface of the network routing device.

15. The method of claim 13 further comprises forwarding the data packet through a public-side interface of the network routing device

16. The method of claim 13 further comprises receiving the data packet at a network device having an IP address that matches the destination IP address embedded in the destination IP address field; and extracting the original source private IP address from the options field and the IP address for the network routing device from the source IP address field of the packet header for subsequent communications with the originating network device.

17. The method of claim 13 further comprises:
receiving the data packet at a another network routing device having a private-side interface IP address;
appending the IP address for the network routing device to the original source private IP address in the options field of the packet header; and
formatting the source IP address field of the packet header with a public interface IP address for the another network routing device prior to forwarding the data packet.

18. The method of claim 17 further comprises receiving the data packet at a destination network device having an IP address that matches the destination IP address embedded in the destination IP address field; and extracting the original source private IP address and the IP address for the network routing device from the options field and the IP address for the another network routing device from the source IP address field of the packet header for subsequent communications with the originating network device.

19. A network routing device positioned between a private network and a public network in a packet-switched network system, the network routing device adapted to receive data packets at a private-side interface, the data packets being formulated in accordance with Internet Protocol (IP) and having an original source private IP address in a source destination IP address field of the packet header, the network routing device being operable to format an options field of the packet header with the original source private IP address and format the source IP address field of the packet header with a public interface IP address for the network routing device prior to forwarding the data packet.

20. A packet header of a data packet formulated in accordance with the Internet Protocol, the data packet embodied in a carrier wave, comprising an IP address for an originating network device embedded in an options field of the packet header.

21. The packet header of claim 20 further comprises an embedded address indicator residing in the options field of the packet header, the embedded address indicator indicative of the presence of the IP address in the options field.

22. A packet header of a data packet formulated in accordance with the Internet Protocol, the data packet embodied in a carrier wave, comprising an IP address for a destination network device embedded in an options field of the packet header.

23. The packet header of claim 22 further comprises an embedded address indicator residing in the options field of the packet header, the embedded address indicator indicative of the presence of the IP address in the options field.

24. A traversable addressing scheme that uniquely identifies a network device residing in a private network and having at least one network routing device interposed between the network device and a public network, comprising concatenating an IP address for the network device in a predefined order with a public side interface IP address for the at least one network routing device to form a traversable network address.

25. The traversable addressing scheme of claim 24 further comprises formatting an options field of a IP packet header with the traversable network address.

26. The traversable addressing scheme of claim 24 wherein the public side interface IP address for the at least one network routing device is appended to the IP address for a source network device.

27. The traversable addressing scheme of claim 24 wherein the public side interface IP address for the at least one network routing device is prepended to the IP address for a destination network device.

28. The traversable addressing scheme of claim 24 further comprises registering the traversable network address of the network device with a domain name server.

29. The traversable addressing scheme of claim 24 further comprises determining the traversable network address of the network device by accessing the domain name server.

30. The method of claim 13 further comprises repeating the process at each network routing device interposed between the originating network device and a public network.
